(19) United States
(12) Patent Application Publication
(10) Pub. No.: US 2025/0097127 A1
(43) Pub. Date: Mar. 20, 2025

(54) System and Method of Classification of Traffic Flows in a Communication Network

(71) Applicant: ALLOT LTD., Hod HaSharon (IL)

(72) Inventor: Yaakov Stein, Jerusalem (IL)

(21) Appl. No.: 18/408,646

(22) Filed: Jan. 10, 2024

(30) Foreign Application Priority Data
Sep. 14, 2023 (KZ) 2023/0607.1

(51) Int. Cl. H04L 43/062; H04L 41/16; H04L 43/026

(52) U.S. Cl. CPC H04L 43/062; H04L 41/16; H04L 43/026

(57) ABSTRACT

Systems, devices, and methods for efficiently, innovatively and selectively combining Deep Packet Inspection (DPI) units with their large repertoire of applications and fast classification times, with Behavioral Flow Classification (BFC) units that remain functional even when a traffic flow is fully encrypted. A system combines a DPI unit with an Application Category Classification (ACC) unit of a BFC subsystem, and a set of fine-grained Deep Flow Inspection (DFI) units of a BFC subsystem, that identify the application given the known application category. Optionally, a Server Address Classification (SAC) unit is invoked, to provide additional insights. The combined units, that are innovatively invoked in a stepped or conditional activation process, selectively on a per-traffic-flow basis, enjoy the speed, efficiency, accuracy, and broad coverage of DPI units for unencrypted and partially-encrypted traffic flows; while also being functional and useful for classifying fully-encrypted traffic flows; and while improving performance, reliability, and resilience of communication networks.

### CROSS-REFERENCE TO RELATED APPLICATIONS

This patent application claims priority from Kazakhstan patent application number 2023/0607.1, filed on Sep. 14, 2023 in the National Institute of Intellectual Property (NIIP) of Kazakhstan, which has been Allowed, and which is hereby incorporated by reference in its entirety.

### FIELD

The present invention relates generally to classifying traffic flows in communications networks, and in particular to deep packet inspection (DPI) and behavioral flow inspection. More specifically, embodiments of the invention are devices, systems and methods that classify communications traffic flows when some of these traffic flows are fully encrypted.

### BACKGROUND

A packet flow in a packet communications network is a set of related packets exchanged between the same endpoints, such as between a client and server for web services, or between two peers for conferencing. Classification of a communications traffic flow means assigning it an application category (such as video streaming, or video conferencing) and/or an application identifier (such as YouTube or Zoom), and/or a device type (such as a smartphone versus a PC).

Classification is conventionally performed using Deep Packet Inspection, or DPI. A DPI unit observes field-value packet metadata, for example, Internet Protocol (IP) addresses, Domain Name System (DNS) response fields, protocol number, Transmission Control Protocol (TCP) ports, Server Name Indication (SNI), and/or Application-Layer Protocol Negotiation (ALPN) data from (or related to) individual packets comprising the flow, and matches this per-packet metadata with reference values that are expected for particular applications. State-of-the-art DPI systems are often able to recognize in this way thousands of different applications from dozens of application categories, and can often accurately classify traffic flows after observing a small number of packets.

Recently there has been a trend towards encrypting more and more per-packet field values due to privacy concerns. While this trend is aimed at thwarting pervasive monitoring, it hinders the functioning of DPI, and/or it may negatively impact realizing the aforementioned motivations for classification of traffic flows.

A partial solution in the prior art is behavioral flow classification, that utilizes machine learning (ML) techniques to recognize the characteristic behaviors of applications and/or users, based on per-flow features such as inter-packet timings and sequences of packet sizes, without requiring access to per-packet field values. State-of-the-art behavioral flow classification systems are sometimes able to recognize in this manner a few tens of different applications from a small number of application categories, and accurately classify traffic flows after observing a relatively large number of packets. Machine learning methods also necessitate greater computational resources and consume more energy than DPI methods.

For these reasons existing behavioral flow classification technologies are only partially able to replace DPI systems for restricted use cases, and cannot be viewed as a drop-in DPI replacement for all motivations for classifying traffic flows.

### SUMMARY

The present disclosure describes systems and methods for combining deep packet inspection (DPI) systems with their large repertoire of applications and fast classification times with behavioral flow classification (BFC) systems that remain functional despite full encryption.

Embodiments of the present disclosure relate to combined systems comprising DPI and BFC subsystems that rapidly and accurately classify communication traffic flows when many, but not all, flows are fully encrypted. Such situations will be prevalent during the time period from the initial introduction of full encryption and until the last applications and services have been upgraded.

An embodiment of the present disclosure comprises a DPI subsystem and a BFC subsystem that both attempt to identify a traffic flow's application and may also return its associated application category. In this embodiment the combined system first attempts to identify a traffic flow's application using DPI, and if successful the combined system returns the DPI's fine-grained application classification and optionally its associated application category. If the DPI is unsuccessful due to necessary per-packet field values being encrypted, BFC is then attempted. If the BFC is successful in identifying the application, then the combined system returns the BFC's classification into application and optionally its associated application category.

Another embodiment of the present disclosure comprises DPI, server address classification (SAC) and BFC subsystems. In this embodiment the combined system first attempts to identify a traffic flow's application using DPI, and if successful the combined system returns the DPI's fine-grained application classification and optionally its associated application category. If the DPI is unsuccessful, SAC is then attempted. If the SAC is successful, the combined system returns the SAC's classification. If the SAC is unsuccessful, BFC is attempted. If the BFC is successful in identifying the application, then the combined system returns the BFC's classification.

A preferred embodiment of the present disclosure comprises a DPI subsystem (or unit, or component) that attempts to identify a traffic flow's application and may also return its associated application category, an application category classification (ACC) BFC subsystem that attempts to classify traffic flows into an application category, and a set of deep flow inspection (DFI) BFC subsystems, that attempt to identify specific applications given the known application category. In this embodiment the combined system first attempts to identify a traffic flow's application using DPI, and if successful the combined system returns the DPI's classification into application and optionally its associated application category. If the DPI is unsuccessful due to necessary per-packet field values being encrypted, then application category classification is attempted. If the ACC is unsuccessful, then the combined system admits defeat, and optionally stores features for future improvement. If the ACC is successful, then fine-grained application classification is attempted by applying the appropriate deep flow inspection system from amongst the set of DFI systems. If the DFI is successful, then the combined system returns the classification of the DFI system that was applied. If the DFI is unsuccessful, then the combined system returns the application category as determined by the ACC.

This summary has been provided solely to introduce concepts that are more fully described in the Detailed Description below. It is not intended to limit the scope of the claimed subject matter.

### BRIEF DESCRIPTION OF THE DRAWINGS

FIG. 1 depicts various use cases of packet flow classification.

FIG. 2 depicts the high-level structure of a conventional DPI system.

FIG. 3 depicts the high-level structure of a behavioral flow classification (BFC) system.

FIG. 4 depicts a combined system comprising a DPI subsystem and a BFC subsystem.

FIG. 5 depicts a combined system comprising a DPI subsystem which further determines whether layer 3 addresses are unconcealed, an SAC subsystem, and a BFC subsystem.

FIG. 6 depicts a combined system comprising a DPI subsystem, an SAC subsystem, and a BFC subsystem.

FIG. 7 depicts a combined system comprising a DPI subsystem, an ACC subsystem, and a exemplary set of DFI subsystems.

### DETAILED DESCRIPTION OF SOME DEMONSTRATIVE EMBODIMENTS

In modern communications networks such as the Internet, information is exchanged in discrete units known as packets, and a sequence of related packets exchanged between the same parties is known as a packet flow. For example, a voice call taking place over the Internet protocol (VOIP) comprises a bidirectional packet flow, each individual packet containing some time duration of encoded audio from one party.

In the Internet protocol (IP) suite packets are crafted to be self describing, comprising a sequence of packet headers before the user content (e.g., the encoded audio). This structure facilitates standards-based recursive parsing by the intended recipient, but has the unintended consequence of revealing all the packet's information to potentially malicious parties who may observe the packet on its way from source to destination. This situation was rectified by adding various cryptographic mechanisms, and it is now often stated that the great majority of Internet traffic is encrypted.

However, the statement regarding ubiquity of encryption actually only signifies that user content is encrypted, while Internet packet headers still leak metadata (data about data). This metadata is routinely exploited by Internet service providers (ISPs) to identify the application being used, identification that is crucial for various purposes, including differential charging, traffic management, quality of service assurance, analytics, legal interception, digital enforcement, and communications security.

Differential charging refers to charging the customer according to the services consumed; for example, certain services may be free, others reduced price up to a usage cap, while yet others may be premium services involving additional charges. Quality of service assurance refers to prioritizing packet delivery according to the requirements of each application, for example interactive applications such as video conferencing and gaming require minimal latency while they may consume data at low to moderate rates, while video streaming requires high data-rate but is relatively insensitive to latency. Traffic management refers to maintaining service capacity despite congestion or fault conditions, which typically entails prioritizing critical traffic over background traffic. Analytics refers to preparation of reports of applications consumed and their quality of service, for purposes of planning and customer service. Legal interception refers to identification and collection of specific traffic as required by law enforcement, such as when a court order specifies retaining only voice traffic from a specific suspect. Digital enforcement refers to other legal or homeland security functionalities, such as blocking child pornography or bomb construction videos, or tracking down terror cells. Security refers to protecting consumers from potentially dangerous traffic, such as malware, and protecting servers from denial of service (DOS) attacks or from distributed DoS (D-DOS) attacks.

The use cases of the previous paragraph still do not encompass the entire spectrum of motivations for the use of DPI. Additional uses are detecting usage of geo-spoofing Virtual Private Networks (VPNs) for digital rights management (DRM) enforcement, root cause analysis for network degradations and failures, statistics gathering for performance and quality measurement as required by regulators, congestion detection and mitigation, and many more. In addition, DPI systems are frequently called upon to fulfill additional functions, such as identification of device type or the number of connected devices. For example, a service provider may offer a mobile service plan, and a more expensive fixed wireless access (FWA) plan. The mobile service plan may limit a user to three tethered devices at any one time, while the FWA plan enables simultaneously connecting an unlimited number of devices. There may also be special smart-home service plans designed to serve numerous Internet of Things (IoT) devices, while other plans may block or limit such devices.

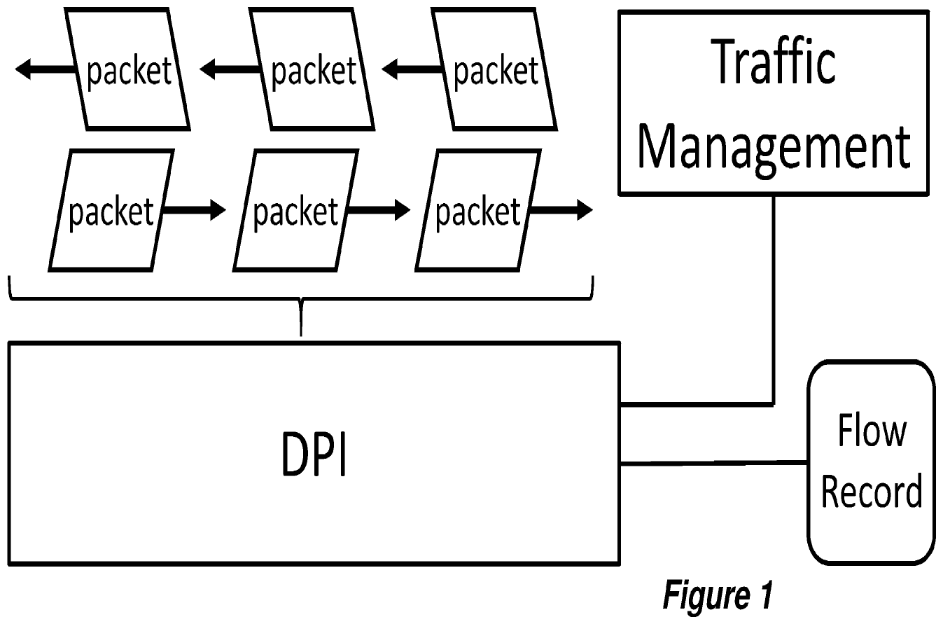

Several DPI use cases are depicted in FIG. 1. Packets flowing in both inbound (from Internet to local hosts) and outbound (from local hosts towards the Internet) directions are observed by the DPI system, which may be inline or in tap mode. Inline operation means that the DPI inputs packets, processes them, and then forwards them. Tap mode means that the DPI system receives a copy of the packets, but is not responsible for their forwarding. DPI results are sent as flow records to a reporting mechanism or to other functionalities as required by the use case. When the use case is analytics or differential charging then tap mode is sufficient and the reporting mechanism either calculates various statistics as desired by the service provider or required by regulation, or updates the charging function regarding the application consumed. When the use case is security or traffic management, an inline component, which may or may not be integrated with the DPI, either blocks traffic or rate-limits it according to the DPI classification.

Identification of packet flows as belonging to specific applications or services is conventionally performed by DPI (deep packet inspection). DPI systems are highly sophisticated classifiers that exploit the aforementioned metadata leakage. DPI comprise carefully crafted rule sets that map logical combinations of metadata to applications. In operation, a DPI unit associates packets to packet flows, and parses each individual packet exploiting the self-describing nature of unencrypted packets conforming to the IP protocol suite. The parsing enables extraction of per-packet unencrypted metadata. The DPI system then compares all the metadata collected from packets belonging to a packet flow to application signatures stored in an application signature rule-set, until a match is found. State-of-the-art DPI systems are able to recognize in this fashion thousands of different applications from dozens of application categories, and accurately classify traffic flows after observing a very small number of packets. U.S. Pat. No. 8,902,776, titled “DPI Matrix Allocator”, describes the use of DPI for traffic management, and is hereby incorporated by reference in its entirety.

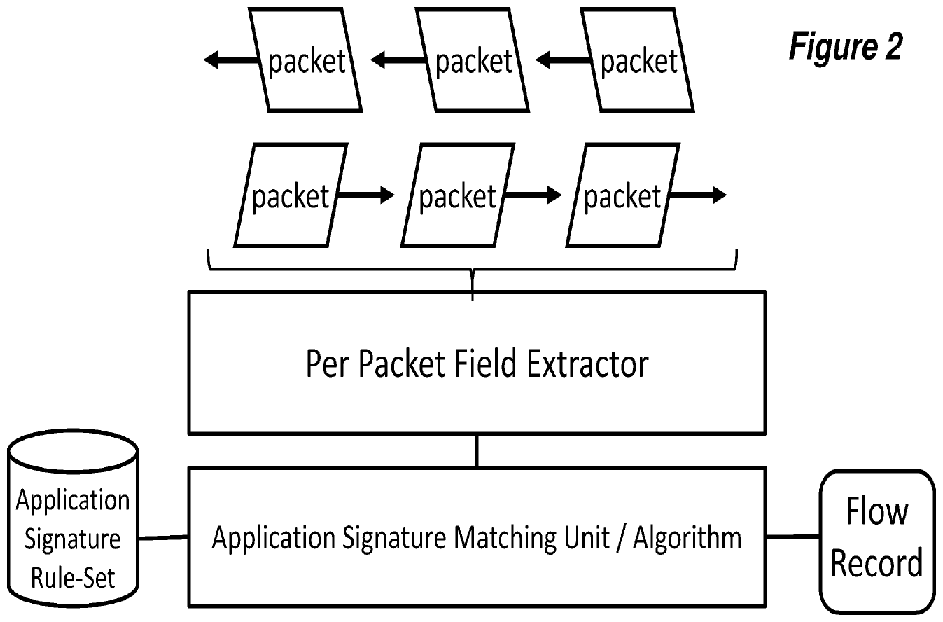

FIG. 2 depicts the high-level structure of a conventional DPI system. Packets flowing in both inbound and outbound directions are observed by the DPI system, which may be inline or in tap mode. The system comprises a per-packet field extractor that parses each packet and extracts both well-known fields as specified by standards organizations (such as IP addresses, IP protocol, TCP and User Datagram Protocol (UDP) port numbers, TCP options, Transport Layer Security (TLS) fields such as SNI and ALPN, http fields such as request method and user agent) and application-specific fields that need to be discovered by protocol analysis and/or reverse engineering. The per-packet field extractor must operate in real-time, on average completing the parsing of a packet before the next packet arrives. For a single 100 Gbps line this translates to parsing about 150 million packets per second (assuming minimal size packets), or about 6.7 nanoseconds per packet.

The DPI system further comprises an application signature matching algorithm. This algorithm accesses the application rule-set which contains application signatures, that is, logical combinations of per packet fields for packets in a flow that are characteristic of flows emanating from a particular application or service. By comparing the extracted per-packet fields with the application rule-set, a match may be found. The application label of the matching rule is output as a flow record. If no match is found a failure indication is returned. Optionally, the application category corresponding to the identified application may be returned as part of the flow record.

As a very simple example, a particular application may be characterized by having all packets with protocol field indicating TCP, and having packets from client to server using TCP destination port 443 indicating HTTP over TLS, and having in the TLS Client Hello packet a particular SNI field value.

It was previously stated that that the great majority of Internet traffic is encrypted. For example, at the current time over 80% of all web packets employ HTTPS (hypertext transfer protocol secure) which utilizes TLS (transport layer security), a cryptographic protocol that provides authentication, data integrity, and confidentiality. However, in current practice the DNS (domain name system) queries and responses that map the server's name to its IP address; the TLS Client Hello which includes such metadata as SNI (server name indication) and ALPN (application layer protocol negotiation); the TCP port numbers and options, and various other header fields are still sent in the clear. These fields are observed by DPI systems, and their appearance individually and in combination may be utilized to infer the application used or service consumed, the type of user device, and the quality of service experienced.

Recent trends towards enhancing privacy of Internet users, especially vis-à-vis pervasive monitoring by governmental agencies, have led to gradually more and more encryption of packet headers, in addition to user content. For example, an end user desiring to hide TCP options can employ the newer QUIC protocol. One desiring to censor TLS metadata such as SNI can employ encrypted client hello (ECH). And someone desiring to conceal almost all metadata can employ virtual private network technology, wherein all packet headers are concealed, and the entire encrypted packet is placed behind an outer header carrying no application-relevant metadata.

Hiding metadata is an effective weapon in the battle against pervasive monitoring and revealing private information to malicious parties, but as collateral damage the job of DPI systems becomes more complicated or even impossible. This directly impacts the crucial functions for which DPI was employed in the first place, including differential billing, traffic management, quality of service assurance, analytics, and communications security.

However, even encrypting all packet header fields does not truly remove all distinctive metadata. At least three characteristics remain. First, the sequence of directions of packets comprising the packet flow (e.g., whether from client to server or from server to client) may be indicative of the service type. For example, video streaming is characterized by a small number of request (GET) packets from client to server followed by a large number of response (chunk) packets from server back to the client; video calls are on the whole symmetric with approximately equal numbers of packets in each direction. Second, the size of the packets is generally preserved by metadata concealment techniques, or at most modified by the addition of additional header(s). Thus, even a fully encrypted packet flow can be characterized by a tell-tale sequence of packet sizes. For example, video streaming will consist of a large number of very large response or chunk packets from server to client, interspersed with small (ACK) packets from client to server acknowledging their receipt. Thirdly, packet timings are generally not significantly perturbed by metadata obscuration, although they are influenced by the underlying latencies in the network. Concatenating these three per-packet characteristics forms a time series representing an encrypted packet flow, where each element in the time series comprises a timestamp, a direction, and a packet size.

In some cases, in addition to time, direction, and packet size, each packet also comprises additional information. For example, for encrypted web traffic, the transport layer carries two port numbers, one of which may be equal to 443 (indicating encrypted web traffic), and the other a number in the dynamic port range between 49,152 and 65,535. This latter number may be utilized by some embodiments in order to distinguish between different connections, at least for some period of time. Hence in such cases the time series would consist of a timestamp, a direction, a dynamic range port number, and a packet size.

Classifying an application used or service provided based solely on the aforementioned time series is called behavioral flow classification (BFC). Behavioral flow classifiers generally utilize machine learning techniques to recognize the characteristic behaviors of applications and/or users based solely on the flow time series, without needing access to per-packet header field values. Many different machine learning techniques have been applied to this problem, including decision trees, naïve Bayes classifiers, random forests (RF), Adaboost and XGboost, hidden Markov models (HMMs), support vector machines (SVMs), convolutional neural networks (CNNs), recurrent neural networks such as GRU and LSTMs, deep learning, transformers, and many, many more. State-of-the-art BFC systems are able to recognize in this way many tens of different applications from a small number of application categories, and accurately classify traffic flows after observing a relatively large number of packets. Machine learning methods also necessitate greater computational resources and consume more energy than DPI methods. Finally, machine learning methods may misclassify (i.e., classify a flow belonging to one application as belonging to a different application), and may do so with great confidence.

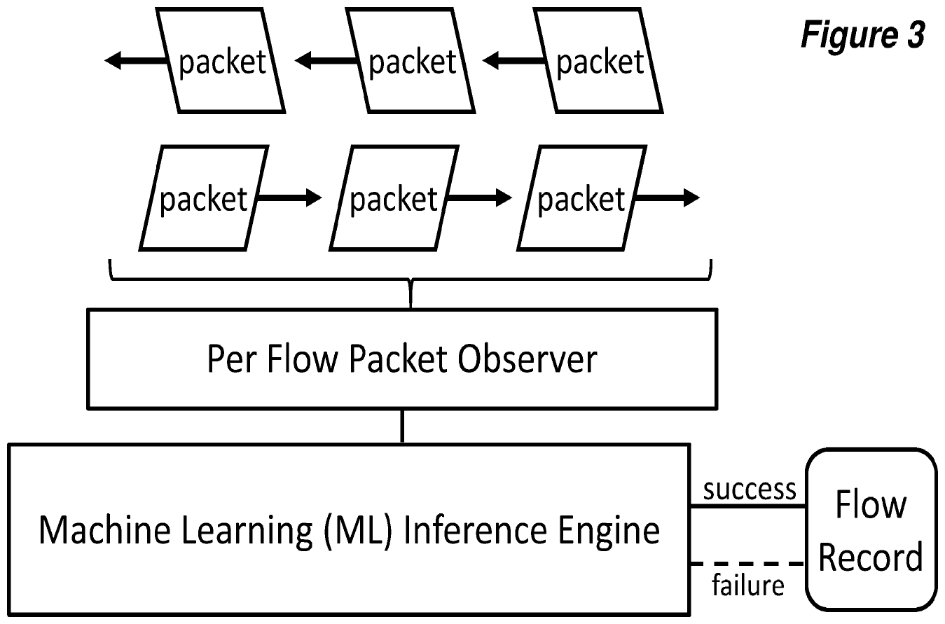

FIG. 3 depicts the high-level structure of a behavioral flow classification (BFC) system. Packets flowing in both inbound and outbound directions are observed by the BFC system, which may be inline or in tap mode. The system comprises a per-flow packet observer that observes each packet associated with a flow and extracts per-packet behavioral including its direction (inbound or outbound), its time of arrival (preferably as compared with the first packet in the flow), and its size (in bytes). It is possible to combine the direction and packet size data by multiplying the packet sizes of outgoing packets by −1, thus creating a single sequence with positive packet sizes for incoming packets and negative packet sizes for outgoing packets. This sequence, along with the packet arrival time of each packet, defines a time series.

The BFC system further comprises a Machine Learning inference engine. This inference engine is generally pretrained with a training set comprising a time series emanating from a set of many applications along with labels representing each respective application. At run-time the inference engine inputs a time series and obtains a vector representing the likelihood of the flow belonging to each application of the set of many applications in the training data. The most likely application label is returned as a flow record. If the predicted application label does not pass predefined criteria for correctness, a failure indication is returned.

A comparison of DPI to BFC demonstrates the advantages and disadvantages of each. DPI is crippled by obscuration of packet headers while BFC needs only time series data. DPI systems may recognize thousands of different applications and services, while few BFC systems today approach a hundred. DPI systems typically classify within a small number of packets, while BFC systems may require dozens of packets or tens of seconds of traffic.

For some use cases speed of classification is vital. For example, while analytics may need only collect data for 15-minute periods and generate reports once a day, blocking malware or blocking the viewing of illegal videos must be almost immediate to be effective. For some use cases minimization of computational resource consumption is vital. For example, the number of Central Processing Unit (CPU) cores and the amount of memory is limited for SMB or enterprise branch offices connected with 1 Gbps or 10 Gbps links, but a significant service provider serving a major city may need to classify flows arriving at speed exceeding 1 Tbps, necessitating a sizeable data center installation. Some use cases (such as traffic management) only require classifying into a small number of broad application categories, while others (e.g., differential billing, digital enforcement) require fine-grained classification of thousands of applications. Finally, DPI system failures are almost always problems of coverage, i.e., not knowing the application in question. Misclassification occurs between related applications (e.g., when a service provided by given provider is confused with another service by the same provider due to common infrastructure). As mentioned before, BFC can fail spectacularly, confusing completely unrelated applications.

This comparison highlights reasons that existing BFC technologies are only able to replace DPI systems for restricted use cases, and can't be viewed as a drop-in DPI replacement for all motivations for classifying traffic flows.

However, it is not envisaged that all users, applications, and services will adopt the most comprehensive forms of metadata concealment immediately upon their standardization. In fact, typical new protocol adoption curves have an initial low adoption period, where only a few percent of users will attempt usage, followed by a period of rapid growth driven by major players adopting the protocol, followed by a long tail during which legacy systems eventually migrate to the new protocol.

As an example, VPN technologies have been available for many years, yet other than telecommuters and travelling salespeople few people even knew about them until the covid-driven trend of working from home, which introduced them to business VPNs. This drove usage from a few percent to over 30 percent. Since then, there has been little increase, although Apple's iCloud Private Relay technology may cause another hocky-stick increase at some point in time.

As another example, QUIC usage was at the few percent mark for a long time until decisions by several major players to default to it, which drove usage to about the 30 percent mark. Since then, usage increase has plateaued, with a long tail of nonadopters who don't see any advantage in expensive upgrades. It is expected that TCP will continue transporting a significant fraction of traffic for years, if not decades, to come.

Another example is encrypted DNS, where DNS over TLS (DOT), DNS over HTTPS (DoH), and the newest DNS over QUIC (DoQ) are together still less than 5% of DNS traffic from end-users to first resolvers. Finally, ECH, which is expected to be adopted as a proposed standard in early 2024, is only being warily tried by very early adopters, and is not expected to significantly grow in usage for some time.

For these reasons it is envisaged that the most popular services and user applications will rapidly adopt full concealment of metadata, while the long tail of smaller and less popular services and applications will remain for many years in the current phase with encrypted user content but only partially concealed metadata. While there may be under ten extremely popular applications, they may account for the majority of Internet volume, while each of the thousands of less popular applications drives a miniscule amount of traffic.

In the course of the time period during which full metadata concealment is not fully adopted, it would be advantageous to combine deep packet inspection and behavioral flow classification to obtain the advantages of both. DPI could quickly and accurately classify packet flows containing at least some unconcealed metadata, while BFC will handle completely abstruse flows. And relieving the BFC from having to handle the popular applications that account for the majority of volume minimizes the BFC computational resource drain.

At some point in the more distant future the large majority of traffic will be fully encrypted, and the DPI coverage will no longer warrant its retention. By then the BFC will have become enriched in coverage and improved in accuracy, so that it will be empowered to fulfil the function of today's DPI. Moreover, by then alternative mechanisms may be deployed, such as direct communications between applications and network elements.

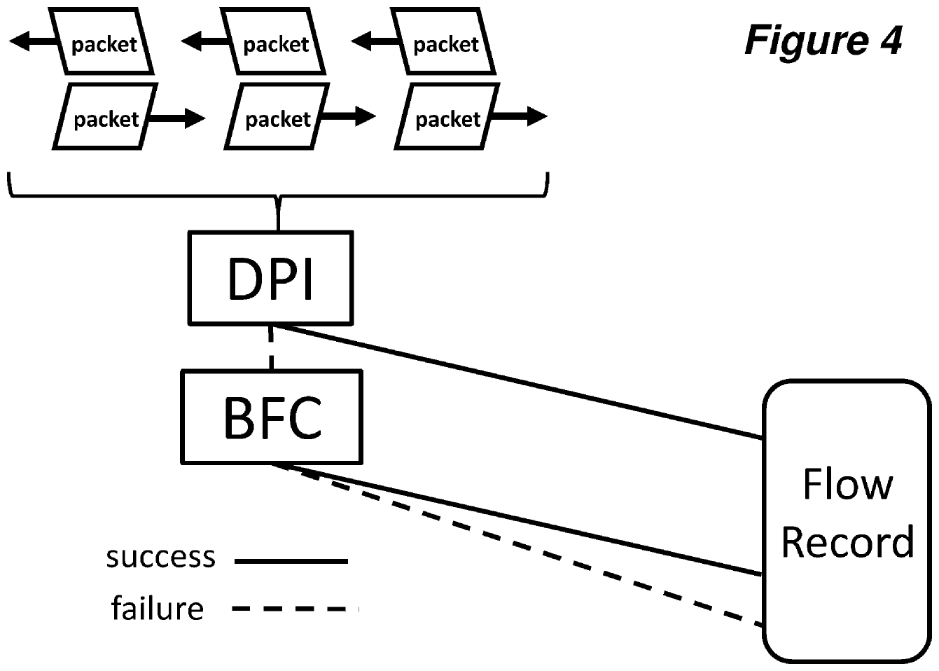

In a first embodiment of the disclosed invention, depicted in FIG. 4, a packet flow is first inspected by a conventional DPI system acting as a DPI subsystem of the combined system. If the packet is not fully encrypted, that is, enough recognizable metadata is visible to the DPI subsystem, the combined system will return a flow record containing the DPI's classification. If unsuccessful, instead of sending a failure indication, the packet flow is next inspected by a BFC subsystem. If the BFC subsystem's inference engine is successful in identifying the application, a flow record containing the BFC's classification is returned. If the BFC is unsuccessful, a failure indication is returned.

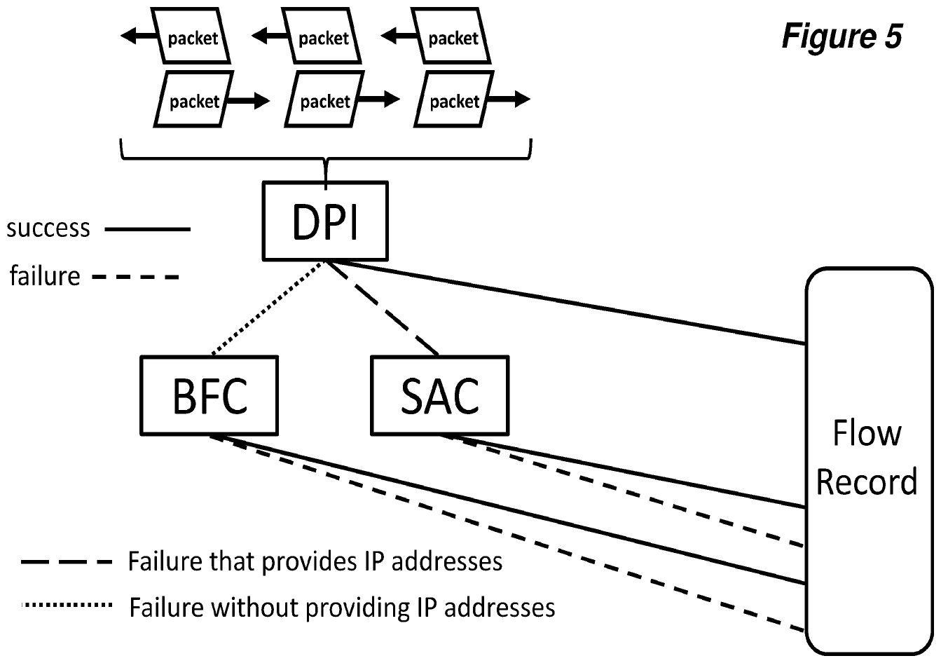

In another embodiment of the disclosed invention, depicted in FIG. 5, a packet flow is once again first inspected by a conventional DPI system acting as a DPI subsystem of the combined system. If enough recognizable metadata is visible to this DPI system, the combined system will return a flow record containing the DPI's classification. If unsuccessful, the DPI subsystem further determines whether the original server layer 3 address (IP destination address of outgoing packets) remains visible or is concealed. For example, ECH only encrypts layer 4 and above leaving layer 3 headers visible, while VPNs conceal the layer 3 header as well. If the server IP address is concealed the BFC subsystem is invoked as in the first embodiment. If the server IP address remains visible, a server address classifier (SAC) subsystem is invoked. The SAC attempts to associate an application with a server address. If successful, the combined system returns a flow record containing the SAC's classification; if unsuccessful, a failure indication is returned.

The association of an application to a server address may be accomplished passively or actively. A passive SAC may attempt to perform an inverse IP address lookup on the server address to obtain a server uniform resource locator (URL), i.e., a web address, which in most cases uniquely maps to an application or service. Alternatively, a passive SAC may observe, in the background, all DNS responses and save server URLs, for each server IP address observed; during run-time a look-up is performed to map the server IP address to a URL, and the URL is associated with an application. Even if the client of the current flow used encrypted DNS to lookup the server's IP address, it is sufficient for some client to lookup this same server's address using unencrypted DNS for this scheme to succeed. An active SAC may periodically perform DNS queries on popular URLs, and create a similar look-up table.

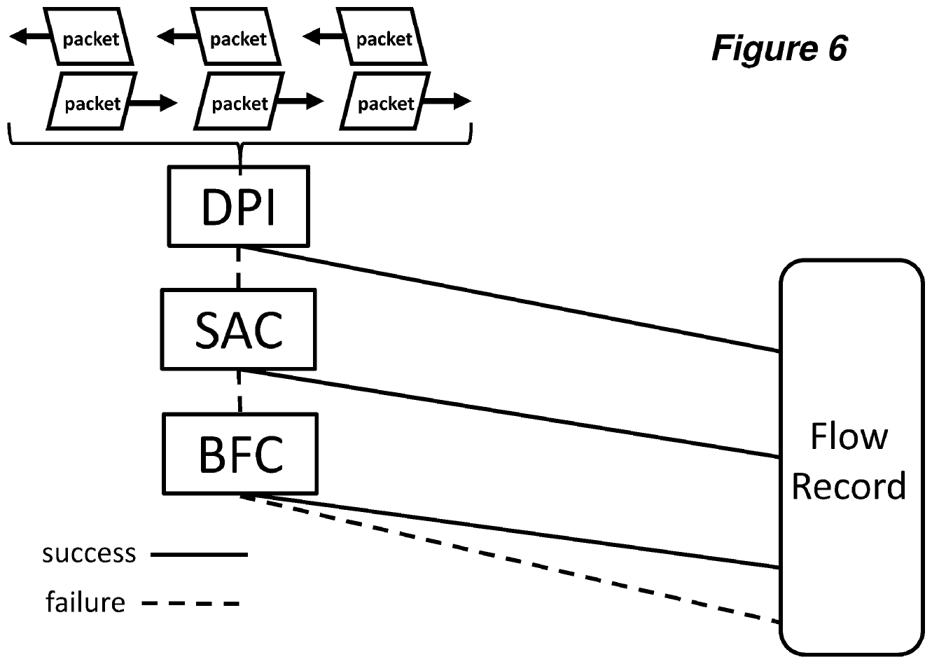

In an alternative embodiment of the disclosed invention, depicted in FIG. 6, a packet flow is once again first inspected by a conventional DPI system acting as a DPI subsystem of the combined system. If enough recognizable metadata is visible to this DPI system, the combined system will return a flow record containing the DPI's classification. If unsuccessful, the SAC is immediately invoked to attempt to associate an application with a server address. If successful a flow record is returned, if unsuccessful a BFC subsystem is invoked. If successful, the combined system returns a flow record containing the BFC subsystem's classification. If unsuccessful, a failure indication is returned.

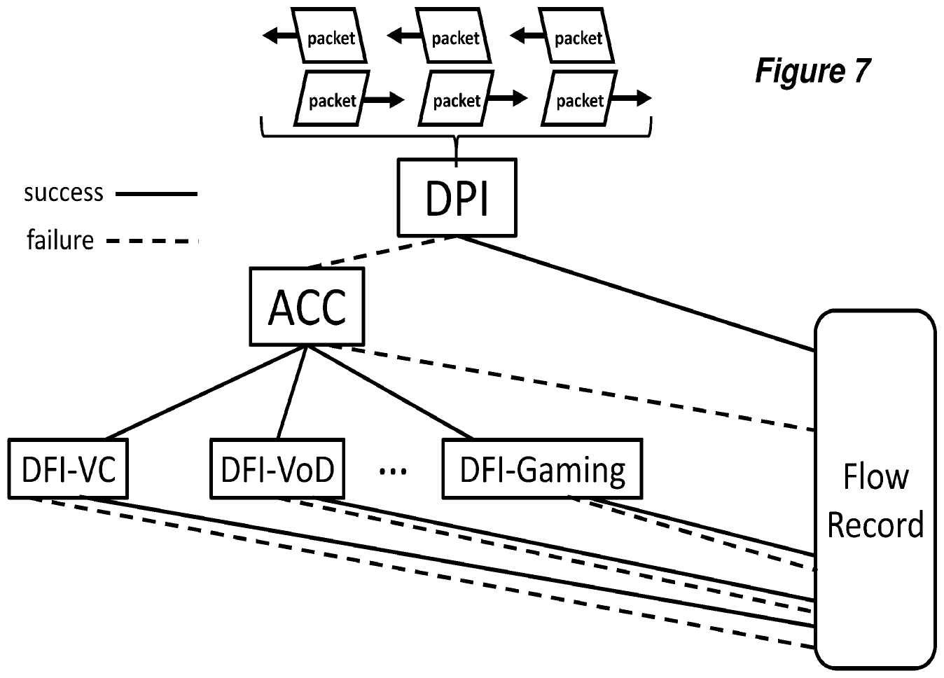

In a preferred embodiment of the disclosed invention, depicted in FIG. 7, a packet flow is once again first inspected by a conventional DPI system acting as a DPI subsystem of the combined system. If enough recognizable metadata is visible to this DPI system, the combined system will return a flow record containing the DPI's classification. If unsuccessful, an application category classifier (ACC) is invoked, which utilizes a machine learning inference engine to predict the application's category from among a small number of broad application categories, such as “video conferencing”, “video streaming” (i.e., video on demand), voice over IP (VOIP), gaming, “social networking”, “file transfer”, shopping, or “generic browsing”. In general, a small number of application categories suffices.

For many use cases of flow classification, application category may be all that is needed. For example, for congestion management there may be a policy that during times of high communications resource utilization, file transfer should be rate limited (thus slowing it down but maintaining service), while VOIP and video conferencing should not be restricted. Similarly, video streaming may be rate limited causing some quality degradation, while service is maintained.

If the ACC is unsuccessful in determining a broad application category a failure indication is returned. If successful, the combined system next attempts to determine a fine-grained application classification. For this purpose, a deep flow inspection (DFI) BFC, from a set of DFIs, is invoked.

Since the ACC was successful the combined system knows the broad application category, and can invoke a DFI specific for the application category discovered. A DFI that is specific to a particular application category may be smaller and more accurate than BFCs that need to simultaneously distinguish between many applications belonging to different categories.

In this embodiment there will be DFIs for at least some of the application categories. For example, a DFI-VC for video conferencing, that has been trained to differentiate between various common video conferencing applications. Similarly, a DFI-VOD for video on demand, that has been trained to differentiate between various common video streaming applications. Likewise, DFI-gaming for gaming services, that has been trained to differentiate between various common on-line games.

Some embodiments may utilize one or more components, operations and/or methods as described in U.S. Pat. No. 11,552,867, titled “System, device, and method of classifying encrypted network communications”, which is hereby incorporated by reference in its entirety (e.g., particularly for identifying that the end-user device is browsing to a particular website or type of websites, and/or for performing website fingerprinting or other website detection or website classification even if the network traffic is encrypted); and/or in U.S. Pat. No. 8,902,776, titled “DPI matrix allocator”, which is hereby incorporated by reference in its entirety.

If the DFI invoked is successful, the combined system returns a flow record containing the fine-grained application as identified by the invoked DFI, and optionally the application category as was determined by the ACC. If the DFI is unsuccessful, then the combined system returns only the application category as was determined by the ACC.

For at least some period of time, some or many traffic flows will remain only partially encrypted, and thus will remain amenable to classification by DPI analysis performed by the DPI subsystem. Some embodiments may utilize this in order to label such traffic flows, that were successfully classified by the DPI subsystem and/or that were successfully classified by the SAC subsystem, in order to train thereon a Machine Learning (ML) model for classification of other/arbitrary traffic flows (e.g., including traffic flows of encrypted traffic or fully-encrypted traffic or partially-encrypted traffic or non-encrypted traffic). Such a trained ML model may then be invoked to classify unlabeled traffic flows, including fully encrypted ones.

Some embodiments may be implemented by utilizing one or more hardware components and/or software components; by utilizing, for example: a hardware processor configured to execute code and process data; a memory unit (e.g., Random Access Memory (RAM), Flash memory, volatile memory) configured to store code and/or data; a storage unit (e.g., non-volatile storage unit, hard disk drive, solid state drive); one or more input units (e.g., keyboard, mouse, keypad, microphone); one or more output units (e.g., screen, monitor, audio speakers); one or more wireless and/or wired communication units (e.g., transceiver, transmitter, receiver, transmitter-receiver, modem, router, switch, hub, other network element); a power source (mains electricity; battery; rechargeable battery; solar panel or solar power source; renewable energy power source); an Operating System (OS) with drivers and applications or “apps”; and/or other units or modules.

Some embodiments may specifically provide devices, system, and methods for Information Technology and for Communications (e.g., communications among computers; communications over the Internet; communications over a cellular communication network), and/or for improving the flow of packets and/or data across a communication system; and/or for improving the Quality of Service (QOS) and/or the Quality of Experience (QoE) of such information technology systems and/or communication systems; and/or for improving the reliability and/or resilience of such information technology systems and/or communication systems. For example, some embodiments may assist a network provider or a communication carrier, to correctly identify that a particular flow of traffic is a live streaming video of a live video conference, which in turn can cause an increase in the bandwidth and/or computing resources that are allocated to such application or flow; whereas, in contrast, some embodiments may correctly identify that another particular flow of traffic is a download of a non-live large data file, which may thus be assigned a lower priority relative to the live streaming video flow, and which may thus be allocated a lower bandwidth or a smaller amount of computing resources. Additionally or alternatively, the correct and accurate and efficient classification of traffic flow or streams-of-packets, by some embodiments of the present invention, may further improve the security and/or reliability and/or resilience of the communication network and the associated Information Technology systems and server; for example, as it may allow such networks and system to identify that a particular stream or traffic flow is legitimate (e.g., a streaming video of a live video conference application) and should thus be served or relayed; or conversely, to selective determine or estimate that a particular traffic flow is possible a part of an attack or a cyber-attack (e.g., part of a Distributed Denial-of-Service (D-DOS) attack) or is other type of illegitimate traffic flow that should be blocked or quarantined or discarded or otherwise handled; thus increasing the overall reliability and/or security and/or resilience of the relevant communication network(s) and their Information Technology infrastructure (e.g., server, router, relay unit, network element).

Some embodiments may specifically be implemented as “green” or environmentally-friendly systems, and/or may actively reduce the power consumption and/or energy consumption that is required by conventional/traditional system to achieve similar goals. For example, a conventional system may attempt to use a Machine Learning (ML) system, that requires a large computational effort and/or a large computing power and/or a large processing time, and thus consumes a large amount of energy, in an attempt to classify a particular flow of packets; whereas, some embodiments of the present invention may achieve the goal of correct classification of a traffic flow by utilizing a reduced amount of energy and/or power and/or computing resources and/or processing resources, thereby providing an environmentally-friendly solution and a power-saving solution over conventional systems, and enabling to save energy and power that is consumed by communication networks and communication devices.

Some embodiments provide a system for classifying packet flows in a communications network, the system comprising: a deep packet inspection (DPI) subsystem (or unit); at least one behavioral flow classification (BFC) subsystem (or unit); wherein said DPI subsystem firstly attempts to classify a packet flow via DPI analysis, and if unsuccessful, then the at least one BFC subsystem attempts to classify said packet flow via BFC analysis.

In some embodiments, the system further comprises: a server address classifier (SAC), that is invoked upon failure of the DPI subsystem to classify said packet flow via DPI analysis; wherein only upon failure of the DPI subsystem to classify said packet flow via DPI analysis, the at least one BFC subsystem is invoked.

In some embodiments, a failure of said DPI subsystem to classify said packet flow via DPI analysis, additionally generates a signal indicating whether or not Internet Protocol (IP) addresses associated with said packet flow are visible; wherein, if said signal indicates that IP addresses associated with said packet flow are visible, then the SAC subsystem is invoked to classify said packet flow; wherein conversely, if said signal indicates that IP addresses associated with said packet flow are not visible, then the SAC is not invoked.

In some embodiments, the SAC subsystem may fail to produce a unique classification, but may produce a set of alternatives, one of which is correct. For example, when multiple applications or services are hosted on a single server behind a single IP address, the SAC subsystem may report all known services or applications utilizing this IP address; but lacking SNI visibility, the SAC subsystem may not be able to decide which particular service is being consumed or which particular application is being used, out of several candidate services or applications that utilize that IP address. In such cases, the task of the BFC subsystem is modified such that it only needs to distinguish among a limited set of alternative services (or applications), rather than all possible services (or applications). This additional information may significantly improve classification accuracy.

In some embodiments, the at least one BFC subsystem comprises: a first BFC unit that comprises an application category classifier (ACC); and also, a second BFC unit that comprises a deep flow inspection classifier for applications belonging to a specific application category.

In some embodiments, the DPI subsystem generates a first output that indicates whether or not the DPI subsystem successfully classified a particular traffic flow; wherein said first output is received by a hardware processor; wherein the hardware processor dynamically and determines, based on said first output, selectively on a per-traffic-flow basis, whether or not to activate the at least one BFC subsystem for classifying said particular traffic flow.

In some embodiments, the hardware processor is configured: (a) to firstly attempt to classify the particular traffic flow via DPI analysis; and (b) if the classification attempt of the particular traffic flow via DPI analysis fails, then to secondly attempt to classify the particular traffic flow via Server Address Classifier (SAC) analysis; and (c) if the classification attempt of the particular traffic flow via SAC analysis fails, then to thirdly attempt to classify the particular traffic flow via BFC analysis.

In some embodiments, the hardware processor is configured: (A) to firstly attempt to classify the particular traffic flow via DPI analysis; and (B) if the classification attempt of the particular traffic flow via DPI analysis fails, and the DPI analysis determined that IP addresses associated with the particular traffic flow are visible, then to secondly attempt to classify the particular traffic flow via Server Address Classifier (SAC) analysis; and (C) conversely, if the classification attempt of the particular traffic flow via DPI analysis fails, and the DPI analysis determined that IP addresses associated with the particular traffic flow are not visible, then to secondly attempt to classify the particular traffic flow via BFC analysis.

In some embodiments, the system is configured to improve performance and/or reliability and/or resilience and/or Quality-of-Service (QOS) and/or Quality-of-Experience (QoE) of a communication network and/or an Information Technology system.

In some embodiments, the system is configured to reduce energy consumption and/or power consumption and/or electricity consumption, that are required for correctly classifying one or more traffic flows in a communication network.

Some embodiments provide a computerized method, comprising: classifying a packet flow in communications network, by performing: (A) firstly, performing a Deep Packet Inspection (DPI) classification attempt to classify a particular packet flow; (B) if, and only if, the DPI classification attempt fails, then: preforming a Behavioral Flow Classification (BFC) attempt to classify said particular packet flow.

Some embodiments provide systems, devices, and methods for efficiently and innovatively combining deep packet inspection (DPI) units with their large repertoire of applications and fast classification times, with behavioral flow classification (BFC) units that remain functional despite full encryption. An embodiment combines a DPI system with an application category classification (ACC) BFC system and a set of fine-grained deep flow inspection (DFI) BFC systems that identify the application given the known application category. The combined systems benefit from the speed, efficiency, accuracy, and broad coverage of DPI systems for unencrypted and partially encrypted cases, while remaining functional for fully encrypted cases. Some embodiments of the invention improve the performance and/or reliability and/or security and/or resilience of an Information Technology system and/or of a communication network. The invention may provide an environmentally friendly solution and a reduced-power solution, for classifying and identifying traffic flows in a communication network, and may utilize a reduced amount of energy or power or processing resources relative to conventional classification systems.

Some embodiments provide a system for classifying packet flows in a communications network, the system comprising: a Deep Packet Inspection (DPI) subsystem; and at least one Behavioral Flow Classification (BFC) subsystem; wherein said DPI subsystem firstly attempts to classify a packet flow via DPI analysis, and if unsuccessful, then the at least one BFC subsystem attempts to classify said packet flow via BFC analysis.

In some embodiments, the system further comprises: a Server Address Classifier (SAC) subsystem, that is invoked upon failure of the DPI subsystem to classify said packet flow via DPI analysis; wherein upon failure of the DPI subsystem to classify said packet flow via DPI analysis, the SAC subsystem is invoked; and wherein only upon failure of the SAC subsystem to fully classify said packet flow, the at least one BFC subsystem is invoked.

In some embodiments, a failure of said DPI subsystem to classify said packet flow via DPI analysis, additionally generates a signal indicating whether or not Internet Protocol (IP) addresses associated with said packet flow are visible; wherein, if said signal indicates that IP addresses associated with said packet flow are visible, then the SAC subsystem is invoked to classify said packet flow; wherein conversely, if said signal indicates that IP addresses associated with said packet flow are not visible, then the at least one BFC subsystem is directly or immediately invoked.

In some embodiments, the SAC subsystem generates a closed list of candidate services that are associated with a particular IP address that is associated with said packet flow, and provides said closed list to the at least one BFC subsystem; and wherein the at least one BFC subsystem classifies said packet flow into one of said closed list of candidate services that were generated by the SAC subsystem.

In some embodiments, the at least one BFC subsystem comprises: (I) a first-level BFC unit that comprises an Application Category Classifier (ACC); and also, (II) at least one second-level BFC unit that comprises a Deep Flow Inspection (DFI) classifier configured to classify applications belonging to a specific application category.

In some embodiments, the system further comprises a BFC subsystem Activation Unit; wherein the DPI subsystem is configured to generate, and to send to the BFC system Activation Unit, a first output that indicates whether or not the DPI subsystem successfully classified a particular traffic flow; wherein the BFC subsystem Activation Unit is configured to dynamically determine, based on said first output received from the DPI subsystem, selectively on a per-traffic-flow basis, whether or not to activate the at least one BFC subsystem for classifying said particular traffic flow.

In some embodiments, the system further comprises a Stepped Activation Controller that is configured: (a) to firstly attempt to classify the particular traffic flow via DPI analysis; and (b) if the classification attempt of said particular traffic flow via DPI analysis fails, then: to dynamically and selectively activate a Server Address Classifier (SAC) subsystem in order to secondly attempt to classify the particular traffic flow via SAC analysis; and (c) if the classification attempt of the particular traffic flow via SAC analysis fails, then: to dynamically and selectively activate the at least one BFC subsystem in order to thirdly attempt to classify the particular traffic flow via BFC analysis.

In some embodiments, the system is configured: (A) to firstly attempt to classify the particular traffic flow via DPI analysis; and (B) if the classification attempt of the particular traffic flow via DPI analysis fails, and the DPI analysis determined that IP addresses associated with the particular traffic flow are visible, then to secondly attempt to classify the particular traffic flow via Server Address Classifier (SAC) analysis; and (C) conversely, if the classification attempt of the particular traffic flow via DPI analysis fails, and the DPI analysis determined that IP addresses associated with the particular traffic flow are not visible, then to secondly attempt to classify the particular traffic flow via BFC analysis.

In some embodiments, the at least one BFC unit employs Machine Learning inference based on a pre-trained Machine Learning model that was trained on pre-classified traffic flows.

In some embodiments, said pre-classified traffic flows are unencrypted traffic flows which are successfully classified by the DPI subsystem.

In some embodiments, said pre-classified traffic flows are unencrypted traffic flows which are successfully classified by a Server Address Classifier (SAC) subsystem.

In some embodiments, said unencrypted traffic flows which are successfully classified by the DPI subsystem, are utilized for training said Machine Learning model which, in turn, is invoked to classify encrypted traffic flows.

In some embodiments, said unencrypted traffic flows which are successfully classified by the SAC subsystem, are utilized for training said Machine Learning model which, in turn, is invoked to classify encrypted traffic flows.

In some embodiments, the at least one BFC subsystem is specifically configured to classify a particular packet flow as belonging to exactly one application out of a set of multiple candidate applications; wherein said set of multiple candidate application comprises at least: (i) a video conferencing application, (ii) a video streaming application, (iii) a gaming application, and (iv) a website browsing application.

In some embodiments, the at least one Deep Flow Inspection (DFI) classifier is specifically configured to detect or to classify packet flows that belong to a video conferencing application.

In some embodiments, the at least one Deep Flow Inspection (DFI) classifier is specifically configured to detect or to classify packet flows that belong to a video streaming application.

In some embodiments, the at least one Deep Flow Inspection (DFI) classifier is specifically configured to detect or to classify packet flows that belong to a gaming application.

In some embodiments, the at least one Deep Flow Inspection (DFI) classifier is specifically configured to detect or to classify packet flows that belong to a website browsing application.

In some embodiments, the system is configured to operate as follows: the packet flow is firstly inspected by the DPI subsystem; if the packet flow is not fully encrypted, and there is sufficient recognizable metadata that is visible to the DPI subsystem, then the DPI returns a flow record indicating partial or full classification data as performed by the DPI subsystem; conversely, if the packet flow is fully encrypted and the DPI subsystem fails to classify the packet flow, then: the packet flow is next inspected by the at least one BFC subsystem which performs BFC analysis; and if the BFC analysis is successful then a flow record containing the BFC-based classification is returned, otherwise, a failure-to-classify indication is returned.

In some embodiments, the system is configured as follows: (a) firstly, said DPI subsystem performs a first attempt to classify a particular packet flow; (b) if, and only if, the DPI classification attempt of step (a) fails, then, a first-level BFC unit that comprises an Application Category Classifier (ACC) is invoked as a second attempt to classify said particular packet flow; (c) if, and only if, the ACC classification attempt of step (b) fails, then, a second-level BFC unit that comprises a Deep Flow Inspection (DFI) classifier is invoked as a third attempt to classify said particular packet flow, wherein classifying a particular packet flows means or comprises classifying said flows as belonging to exactly one application out of a set of multiple candidate applications, and wherein said set of multiple candidate application comprises at least: (i) a video conferencing application, (ii) a video streaming application, (iii) a gaming application, and (iv) a website browsing application.

In some embodiments, the system is configured to operate as follows: the packet flow is firstly inspected by the DPI subsystem; if the packet flow is not fully encrypted, and there is sufficient recognizable metadata that is visible to the DPI subsystem, then the DPI returns a flow record indicating partial or full classification data as performed by the DPI subsystem; conversely, if the packet flow is fully encrypted and the DPI subsystem fails to classify the packet flow, then: the DPI subsystem further determines whether an original server layer 3 address, which is an IP destination address of outgoing packets, remains visible or is concealed; if the server IP address is concealed, then the at least one BFC subsystem is invoked to classify the packet flow; if the server IP address remains visible, then a Server Address Classifier (SAC) subsystem is invoked to classify the packet flow, wherein the SAC subsystem is configured to associate an application with a server address; and if the SAC subsystem is successful then a flow record is returned, containing classification data as generated by the SAC subsystem.

Some embodiments provide a system for classifying a packet flows in a communications network, the system comprising: a Deep Packet Inspection (DPI) subsystem that is firstly invoked as an initial attempt to classify a packet flow; a Server Address Classifier (SAC) subsystem, that is invoked only if the DPI subsystem fails to classify said packet flow via DPI analysis.

In some embodiments, a failure of said DPI subsystem to classify said packet flow via DPI analysis, generates a signal indicating whether or not Internet Protocol (IP) addresses associated with said packet flow are visible; wherein, if said signal indicates that IP addresses associated with said packet flow are visible, then the SAC subsystem is invoked to classify said packet flow; wherein conversely, if said signal indicates that IP addresses associated with said packet flow are not visible, then the SAC subsystem is not invoked.

In some embodiments, the system further comprises: at least one Behavioral Flow Classification (BFC) subsystem, that is invoked only if both said DPI analysis and said SAC subsystem failed to classify said packet flow.

In some embodiments, the DPI subsystem generates a first output that indicates whether or not the DPI subsystem successfully classified a particular traffic flow; wherein said first output is received by a Stepped Invocation Unit; wherein the Stepped Invocation Unit dynamically determines, based on said first output, selectively on a per-traffic-flow basis, whether or not to invoke for classifying said particular traffic flow, at least one of: (i) the SAC subsystem, (ii) the at least one BFC subsystem.

In some embodiments, the system is configured as follows: (a) firstly, said DPI subsystem performs a first attempt to classify a particular packet flow; (b) if, and only if, the DPI classification attempt of step (a) fails, then, the SAC subsystem is invoked as a second attempt to classify said particular packet flow; (c) if, and only if, the SAC classification attempt of step (b) fails, then, a first-level BFC unit that comprises an Application Category Classifier (ACC) is invoked as a third attempt to classify said particular packet flow; (d) if, and only if, the ACC classification attempt of step (c) fails, then: a second-level BFC unit that comprises a Deep Flow Inspection (DFI) classifier is invoked as a fourth attempt to classify said particular packet flow, wherein classifying a particular packet flows means or comprises classifying said flows as belonging to exactly one application out of a set of multiple candidate applications, and wherein said set of multiple candidate application comprises at least: (i) a video conferencing application, (ii) a video streaming application, (iii) a gaming application, and (iv) a website browsing application.

In some embodiments, the system is configured as follows: (a) firstly, said DPI subsystem performs a first attempt to classify a particular packet flow; (b) if, and only if, the DPI classification attempt of step (a) fails, then, the SAC subsystem is invoked as a second attempt to classify said particular packet flow; (c) if the SAC classification attempt of step (b) fails to classify said particular packet flow, and returns a plurality of candidate Internet Protocol (IP) addresses that are possibly associated with said particular packet flow, then, the system invokes one or more classifiers out of: (i) an Application Category Classifier (ACC), and (ii) a Deep Flow Inspection (DFI) classifier, as a classification attempt to distinguish among two or more classification options derived from the plurality of candidate IP addresses.

In some embodiments, a computerized method or a computerized process comprises: classifying a packet flow in communications network, by performing: (a) firstly, performing a Deep Packet Inspection (DPI) classification attempt as a first attempt to classify a particular packet flow; (b) if, and only if, the DPI classification attempt of step (a) fails, then: performing a second attempt to classify said particular classic flow, by selectively invoking on a flow-by-flow basis a flow classification unit selected from the group consisting of: a Behavioral Flow Classification (BFC) unit, a Server Address Classifier (SAC); (c) if, and only if, the secondary attempt of step (b) fails, then: preforming a third attempt to classify said particular classic flow, by selectively invoking on a flow-by-flow basis a not-yet-used flow classification unit selected from the group consisting of: the Behavioral Flow Classification (BFC) unit, the Server Address Classifier (SAC).

Some embodiments provide systems, devices, and methods for efficiently, innovatively and selectively combining Deep Packet Inspection (DPI) units with their large repertoire of applications and fast classification times, with Behavioral Flow Classification (BFC) units that remain functional even when a traffic flow is fully encrypted. A system combines a DPI unit with an Application Category Classification (ACC) unit of a BFC subsystem, and a set of fine-grained Deep Flow Inspection (DFI) units of a BFC subsystem, that identify the application given the known application category. Optionally, a Server Address Classification (SAC) unit is invoked, to provide additional insights. The combined units, that are innovatively invoked in a stepped or conditional activation process, selectively on a per-traffic-flow basis, enjoy the speed, efficiency, accuracy, and broad coverage of DPI units for unencrypted and partially-encrypted traffic flows; while also being functional and useful for classifying fully-encrypted traffic flows; and while improving performance, reliability, and resilience of communication networks.

Some embodiments include a non-transitory storage medium or storage article having stored thereon instructions that, when executed by a machine or a hardware processor, cause the machine or the hardware processor to perform a method as described.

Some embodiments include a system comprising: one or more hardware processors, that are configured to execute code, and that are operably associated with one or more memory units that are configured to store code; wherein the one or more hardware processors are configured to perform a method as described.

In some embodiments, in order to perform the computerized operations described above, the relevant system or devices may be equipped with suitable hardware components and/or software components; for example: a processor able to process data and/or execute code or machine-readable instructions (e.g., a central processing unit (CPU), a graphic processing unit (GPU), a digital signal processor (DSP), a processing core, an Integrated Circuit (IC), an Application-Specific IC (ASIC), one or more controllers, a logic unit, or the like); a memory unit able to store data for short term (e.g., Random Access Memory (RAM), volatile memory); a storage unit able to store data for long term (e.g., non-volatile memory, Flash memory, hard disk drive, solid state drive, optical drive); an input unit able to receive user's input (e.g., keyboard, keypad, mouse, touch-pad, touch-screen, trackball, microphone); an output unit able to generate or produce or provide output (e.g., screen, touch-screen, monitor, display unit, audio speakers); one or more transceivers or transmitters or receivers or communication units (e.g., Wi-Fi transceiver, cellular transceiver, Bluetooth transceiver, wireless communication transceiver, wired transceiver, Network Interface Card (NIC), modem); and other suitable components (e.g., a power source, an Operating System (OS), drivers, one or more applications or “apps” or software modules, or the like).

In accordance with embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range of values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wide Area Network (WAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A system for classifying packet flows in a communications network, the system comprising:
a Deep Packet Inspection (DPI) subsystem; and
at least one timeseries-based and packet-based Behavioral Flow Classification (BFC) subsystem, configured to analyze traffic of encrypted packets having encrypted payload and encrypted headers, and configured to construct a timeseries of elements that correspond to said encrypted packets on a packet-by-packet basis, wherein each element in said timeseries comprises a timestamp of an encrypted packet, a direction of the encrypted packet, and a transmission timing of the encrypted packet;
wherein said DPI subsystem firstly attempts to classify a packet flow via DPI analysis, and if unsuccessful, then the at least one timeseries-based BFC subsystem attempts to classify said packet flow via a timeseries-based BFC analysis that utilizes Machine Learning (ML) to classify the encrypted packets encrypted based on said timeseries of elements;
wherein the system is implemented by utilizing at least a hardware processor.

2. The system of claim 1, further comprising:
a Server Address Classifier (SAC) subsystem, that is invoked upon failure of the DPI subsystem to classify said packet flow via DPI analysis;
wherein upon failure of the DPI subsystem to classify said packet flow via DPI analysis, the SAC subsystem is invoked and performs classification of an Internet Protocol (IP) address of a server associated with said packet flow,
and wherein only upon failure of the SAC subsystem to fully classify said packet flow, the at least one timeseries-based and packet-based BFC subsystem is invoked.

3. The system of claim 2,
wherein a failure of said DPI subsystem to classify said packet flow via DPI analysis, additionally generates a signal indicating whether or not Internet Protocol (IP) addresses associated with said packet flow are visible;
wherein, if said signal indicates that IP addresses associated with said packet flow are visible, then the SAC subsystem is invoked to classify said packet flow and performs classification of an Internet Protocol (IP) address of a server associated with said packet flow;
wherein conversely, if said signal indicates that IP addresses associated with said packet flow are not visible, then the at least one timeseries-based and packet-based BFC subsystem is directly or immediately invoked.

4. The system of claim 3,
wherein if the SAC subsystem fails to produce a unique classification of the traffic flow, then the SAC subsystem generates a closed list of candidate services of different applications that are associated with and are hosted behind a particular IP address that lacks Server Name Indication (SNI) visibility and is associated with said packet flow, and provides said closed list of candidate services to the at least one timeseries-based and packet-based BFC subsystem;
and wherein the at least one timeseries-based and packet-based BFC subsystem utilizes a pre-trained Machine Learning (ML) model that classifies said packet flow into one of said closed list of candidate services of different applications that were generated by the SAC subsystem.

5. The system of claim 1,
wherein the at least one timeseries-based and packet-based BFC subsystem comprises:
a first-level BFC unit that comprises an Application Category Classifier (ACC);
and
at least one second-level BFC unit that comprises a Deep Flow Inspection (DFI) classifier configured to classify applications belonging to a specific application category.

6. The system of claim 1,
further comprising a BFC subsystem Activation Unit,
wherein the DPI subsystem is configured to generate, and to send to the BFC system Activation Unit, a first output that indicates whether or not the DPI subsystem successfully classified a particular traffic flow;
wherein the BFC subsystem Activation Unit is configured to dynamically determine, based on said first output received from the DPI subsystem, selectively on a per-traffic-flow basis, whether or not to activate the at least one timeseries-based and packet-based BFC subsystem for classifying said particular traffic flow.

7. The system of claim 1,
further comprising a Stepped Activation Controller that is configured:
(a) to firstly attempt to classify the particular traffic flow via DPI analysis;
and
(b) if the classification attempt of said particular traffic flow via DPI analysis fails, then: to dynamically and selectively activate a Server Address Classifier (SAC) subsystem in order to secondly attempt to classify the particular traffic flow via SAC analysis;
and
(c) if the classification attempt of the particular traffic flow via SAC analysis fails, then: to dynamically and selectively activate the at least one timeseries-based and packet-based BFC subsystem in order to thirdly attempt to classify the particular traffic flow via timeseries-based and packet-based BFC analysis.

8. The system of claim 1,
wherein the system is configured:
(A) to firstly attempt to classify the particular traffic flow via DPI analysis;
and
(B) if the classification attempt of the particular traffic flow via DPI analysis fails, and the DPI analysis determined that IP addresses associated with the particular traffic flow are visible, then to secondly attempt to classify the particular traffic flow via Server Address Classifier (SAC) analysis;
and
(C) conversely, if the classification attempt of the particular traffic flow via DPI analysis fails, and the DPI analysis determined that IP addresses associated with the particular traffic flow are not visible, then to secondly attempt to classify the particular traffic flow via timeseries-based and packet-based BFC analysis.

9. The system of claim 1,
wherein the at least one timeseries-based and packet-based BFC subsystem employs Machine Learning inference based on a pre-trained Machine Learning model that was trained on pre-classified traffic flows.

10. The system of claim 9,
wherein said pre-classified traffic flows are unencrypted traffic flows which are successfully classified by the DPI subsystem.

11. The system of claim 9,
wherein said pre-classified traffic flows are unencrypted traffic flows which are successfully classified by a Server Address Classifier (SAC) subsystem that is configured to identify IP addresses of servers that lack Server Name Indication (SNI) visibility.

12. The system of claim 10,
wherein said unencrypted traffic flows which are successfully classified by the DPI subsystem, are utilized for training said Machine Learning model which, in turn, is invoked to classify encrypted traffic flows.

13. The system of claim 11,
wherein said unencrypted traffic flows which are successfully classified by the SAC subsystem, are utilized for training said Machine Learning model which, in turn, is invoked to classify encrypted traffic flows.

14. The system of claim 1,
wherein the at least one timeseries-based and packet-based BFC subsystem is specifically configured to classify a particular packet flow as belonging to exactly one application out of a set of multiple candidate applications,
wherein said set of multiple candidate application comprises at least: (i) a video conferencing application, (ii) a video streaming application, (iii) a gaming application, and (iv) a website browsing application.

15. The system of claim 5,
wherein the at least one Deep Flow Inspection (DFI) classifier is specifically configured to detect or to classify packet flows that belong to a video conferencing application.

16. The system of claim 5,
wherein the at least one Deep Flow Inspection (DFI) classifier is specifically configured to detect or to classify packet flows that belong to a video streaming application.

17. The system of claim 5,
wherein the at least one Deep Flow Inspection (DFI) classifier is specifically configured to detect or to classify packet flows that belong to a gaming application.

18. The system of claim 5,
wherein the at least one Deep Flow Inspection (DFI) classifier is specifically configured to detect or to classify packet flows that belong to a website browsing application.

19. The system of claim 1,
wherein the system is configured to operate as follows:
the packet flow is firstly inspected by the DPI subsystem;
if the packet flow is not fully encrypted, and there is sufficient recognizable metadata that is visible to the DPI subsystem, then the DPI returns a flow record indicating partial or full classification data as performed by the DPI subsystem;
conversely, if the packet flow is fully encrypted and the DPI subsystem fails to classify the packet flow, then: the packet flow is next inspected by the at least one timeseries-based and packet-based BFC subsystem which performs timeseries-based and packet-based BFC analysis; and if the timeseries-based and packet-based BFC analysis is successful then a flow record containing the BFC-based classification is returned, otherwise, a failure-to-classify indication is returned.

20. The system of claim 1,
wherein the system is configured as follows:
(a) firstly, said DPI subsystem performs a first attempt to classify a particular packet flow;
(b) if, and only if, the DPI classification attempt of step (a) fails, then,
a first-level BFC unit that comprises an Application Category Classifier (ACC) is invoked as a second attempt to classify said particular packet flow;
(c) if, and only if, the ACC classification attempt of step (b) fails, then,
a second-level BFC unit that comprises a Deep Flow Inspection (DFI) classifier is invoked as a third attempt to classify said particular packet flow,
wherein classifying a particular packet flows comprises classifying said flows as belonging to exactly one application out of a set of multiple candidate applications,
and wherein said set of multiple candidate application comprises at least: (i) a video conferencing application, (ii) a video streaming application, (iii) a gaming application, and (iv) a website browsing application.

21. The system of claim 1,
wherein the system is configured to operate as follows:
the packet flow is firstly inspected by the DPI subsystem;
if the packet flow is not fully encrypted, and there is sufficient recognizable metadata that is visible to the DPI subsystem, then the DPI returns a flow record indicating partial or full classification data as performed by the DPI subsystem;
conversely, if the packet flow is fully encrypted and the DPI subsystem fails to classify the packet flow, then: the DPI subsystem further determines whether an original server layer 3 address, which is an IP destination address of outgoing packets, remains visible or is concealed;
if the server IP address is concealed, then the at least one timeseries-based and packet-based BFC subsystem is invoked to classify the packet flow;
if the server IP address remains visible, then a Server Address Classifier (SAC) subsystem is invoked to classify the packet flow, wherein the SAC subsystem is configured to associate an application with a server address; and if the SAC subsystem is successful then a flow record is returned, containing classification data as generated by the SAC subsystem.

22. A system for classifying packet flows in a communications network,
the system comprising:
a Deep Packet Inspection (DPI) subsystem that is firstly invoked as an initial attempt to classify a packet flow;
a Server Address Classifier (SAC) subsystem, that is invoked if and only if the DPI subsystem fails to classify said packet flow via DPI analysis;
wherein the system is implemented by utilizing at least a hardware processor.

23. The system of claim 22,
wherein a failure of said DPI subsystem to classify said packet flow via DPI analysis, generates a signal indicating whether or not Internet Protocol (IP) addresses associated with said packet flow are visible;
wherein, if said signal indicates that IP addresses associated with said packet flow are visible, then the SAC subsystem is invoked to classify said packet flow;
wherein conversely, if said signal indicates that IP addresses associated with said packet flow are not visible, then the SAC subsystem is not invoked.

24. The system of claim 23, further comprising:
at least one timeseries-based and packet-based Behavioral Flow Classification (BFC) subsystem, that is invoked if and only if both said DPI analysis and said SAC subsystem failed to classify said packet flow.

25. The system of claim 24,
wherein the DPI subsystem generates a first output that indicates whether or not the DPI subsystem successfully classified a particular traffic flow;
wherein said first output is received by a Stepped Invocation Unit,
wherein the Stepped Invocation Unit dynamically determines, based on said first output, selectively on a per-traffic-flow basis, whether or not to invoke for classifying said particular traffic flow, at least one of: (i) the SAC subsystem, (ii) the at least one timeseries-based and packet-based BFC subsystem.

26. The system of claim 22,
wherein the system is configured as follows:
(a) firstly, said DPI subsystem performs a first attempt to classify a particular packet flow;
(b) if, and only if, the DPI classification attempt of step (a) fails, then,
the SAC subsystem is invoked as a second attempt to classify said particular packet flow;
(c) if, and only if, the SAC classification attempt of step (b) fails, then,
a first-level BFC unit that comprises an Application Category Classifier (ACC) is invoked as a third attempt to classify said particular packet flow;
(d) if, and only if, the ACC classification attempt of step (c) fails, then,
a second-level BFC unit that comprises a Deep Flow Inspection (DFI) classifier is invoked as a fourth attempt to classify said particular packet flow,
wherein classifying a particular packet flows comprises classifying said flows as belonging to exactly one application out of a set of multiple candidate applications,
and wherein said set of multiple candidate application comprises at least: (i) a video conferencing application, (ii) a video streaming application, (iii) a gaming application, and (iv) a website browsing application.

27. The system of claim 22,
wherein the system is configured as follows:
(a) firstly, said DPI subsystem performs a first attempt to classify a particular packet flow;
(b) if, and only if, the DPI classification attempt of step (a) fails, then,
the SAC subsystem is invoked as a second attempt to classify said particular packet flow;
(c) if the SAC classification attempt of step (b) fails to classify said particular packet flow, and returns a plurality of candidate Internet Protocol (IP) addresses that are possibly associated with said particular packet flow, then,
the system invokes one or more classifiers out of: (i) an Application Category Classifier (ACC), and (ii) a Deep Flow Inspection (DFI) classifier,
as a classification attempt to distinguish among two or more classification options derived from the plurality of candidate IP addresses.

28. A computerized method, comprising:
classifying a packet flow in communications network, by performing:
(a) firstly, performing a Deep Packet Inspection (DPI) classification attempt as a first attempt to classify a particular packet flow;
(b) if, and only if, the DPI classification attempt of step (a) fails, then:
performing a secondary attempt to classify said particular classic flow,
by selectively invoking on a flow-by-flow basis a flow classification unit selected from the group consisting of: a timeseries-based and packet-based Behavioral Flow Classification (BFC) unit, a Server Address Classifier (SAC);
(c) if, and only if, the secondary attempt of step (b) fails, then:
preforming a third attempt to classify said particular classic flow,
by selectively invoking on a flow-by-flow basis a not-yet-used flow classification unit selected from the group consisting of: the timeseries-based and packet-based Behavioral Flow Classification (BFC) unit, the Server Address Classifier (SAC).
